(19) United States
(12) Patent Application Publication
(10) Pub. No.: US 2022/0390630 A1
(43) Pub. Date: Dec. 8, 2022

(54) SELF-POWERED EXCORE DETECTOR ARRANGEMENT FOR MEASURING FLUX OF A NUCLEAR REACTOR CORE

(71) Applicant: Framatome Inc., Lynchburg, VA (US)

(72) Inventor: Ian McKeag JOHNSON, Forest, VA (US)

(21) Appl. No.: 17/774,534

(22) PCT Filed: Nov. 5, 2020
(86) PCT No.: PCT/IB2020/060431

§ 371 Date: May 5, 2022

(30) Foreign Application Priority Data
Nov. 8, 2019 (US) 62933222

(51) Int. Cl. G01T 3/00; G01T 1/16; G21C 17/108

(52) U.S. Cl. CPC G01T 3/006; G01T 1/1606; G21C 17/108

(57) ABSTRACT

An excore detector assembly for measuring flux outside of a nuclear reactor core. The excore detector assembly includes a housing and at least one self-powered detector inside the housing for measuring flux generated by the nuclear reactor core. The at least one self-powered detector includes a sheath, a detector material section inside the sheath, an insulator between the sheath and the detector material, and a flux signal output line.

The present disclosure relates generally to nuclear reactors and more specifically to detectors for measuring flux outside of nuclear reactor cores.

### BACKGROUND

Typical detectors for measuring flux outside of nuclear reactor cores—i.e., excore detectors, are designed for detecting reactor power by measuring the neutron or gamma flux with detectors mounted outside the reactor core. This type of detector is typically some variation of what is called an uncompensated ion chamber, a compensated ion chamber, a fission chamber, or a BF3 or He3 detector. All of these types of excore detectors have one major characteristic in common—they require a high DC voltage (typically 400 v to 1500 v) be used across two separated cylindrical electrodes with a gas volume between the electrodes. The gas volume must be maintained at the proper pressure and type of gas and the sealed contents need to keep moisture out of the gas volume. The application of the high voltage requires maintaining sufficient isolation between the separate electrode components, providing separate cabling outside the detector and connectors on the high voltage side of the detector and maintaining a high voltage source.

Inside nuclear reactors, local power is measured inside the nuclear reactor core with incore detectors designed to operate and survive in the environment. The incore detectors include self-powered neutron detectors (SPNDs) or self-powered detectors (SPDs). A short section of detector material, lead-wire and crushable ceramic insulators are assembled inside a long thin metal housing. The metal housing is formed of Inconel or stainless steel tubes and is called a sheath. The sheath outer diameter is reduced multiple times crushing the ceramic insulators around the detector material and lead-wire to insulate it from the sheath producing a continuous length SPND or SPD. The detector material within the sheath is aligned within a specific location of the core when inserted. The lead-wire is connected to the bottom of the short section of detector material and extends along the full length of the sheath to carry the electrical signal from the detector material to a connector so it can be transmitted for plant use.

The detector material within the sheath of incore detectors is aligned within a specific location of the core when inserted. The alignment of the detectors is maintained with a cylindrical oversheath of similar materials and crushed around the individual detectors in a similar manner as the sheath for all of the individual detectors. The lead-wire may be connected to an end of the short section of detector material and extending the full length of the sheath to carry the electrical signal from the detector material to a connector so the electrical signal can be transmitted for plant use. There may also be a background signal running parallel to the lead-wire in a background detector, which may be inside the same sheath in a twin lead detector or outside of the sheath as a separate detector.

For incore detectors, when higher than average output signals are needed, a few different techniques are employed conventionally. A first conventional technique for designing incore detectors involves using a specific detector material that outputs sufficiently high signals for the given application. A second conventional technique is to design the incore detectors to be sized large enough to provide sufficiently high signal outputs for the given application. A third conventional technique involves using multiple very long elements of different lengths that cover large parts of the reactor core, then subtracting the signals of the elements and using the difference as the measurement for the one location only covered by one of the elements. A fourth conventional technique is to coil the detector, instead of using a straight detector, to generate a stronger signal than the straight detector can generate.

U.S. patent application Ser. No. 16/173,893, which is commonly assigned and includes the same inventor as the present application, discloses self-powered incore detector arrangements. U.S. patent application Ser. No. 16/149,609, which is commonly assigned and includes the present inventor as a joint inventor, also discloses self-powered incore detector arrangements.

### SUMMARY OF THE INVENTION

An excore detector assembly for measuring flux outside of a nuclear reactor core. The excore detector assembly includes a housing and at least one self-powered detector inside the housing for measuring flux generated by the nuclear reactor core. The at least one self-powered detector includes a sheath, a detector material section inside the sheath, an insulator between the sheath and the detector material, and a flux signal output line.

Embodiments of the excore detector assembly may include one or more of the following features:
at least one moderator surrounding the at least one self-powered detector;
the at least one self-powered detector includes a plurality of self-powered detectors and the at least one moderator is a single moderator surrounding all of the self-powered detectors;
the at least one self-powered detector includes a plurality of self-powered detectors and the at least one moderator is a plurality of moderator tubes, with each moderator tube surrounding a respective one of the self-powered detectors;
the at least one self-powered detector includes a plurality of self-powered detectors;
each of the self-powered detectors is an elongated cylinder;
each of the self-powered detectors is an elongated spiral;
a connector outside of the housing that is connected to the flux signal output lines of the plurality of the self-powered detectors to provide a single signal for all of the plurality of the self-powered detectors;
a frame inside the housing holding the plurality of self-powered detectors in place;
the plurality of self-powered detectors are arranged in a plurality of rows;
the housing is formed of a metallic material, such as aluminum, an aluminum alloy, a titanium alloy, or an austenitic nickel-chromium-based alloy such as Inconel family;
the detector material section is formed of a thermal neutron reaction material capable of capturing neutrons and thereby generating capture gamma to produce energetic electrons for creating a prompt signal;
the detector material section is formed of gadolinium, cadmium, boron, or a material made of at least 75% of at least one of gadolinium, cadmium or boron, or a material made of at least 80% of at least one of gadolinium, cadmium or boron, or a material made of at least 95% of at least one of gadolinium, cadmium or boron;
the at least one self-powered detector includes a spiral detector including a hollow center;
a further detector in the hollow center;
the further detector is a gas volume detector;
the at least one self-powered detector includes a hollow cylindrical detector;
the at least one self-powered detector further includes a cylindrical detector inside the hollow cylindrical detector; and/or
the at least one self-powered detector has a height of approximately half of a core of the nuclear reactor pressure vessel, preferably between 25% and 50% of a core of the nuclear reactor pressure vessel.

### BRIEF DESCRIPTION OF THE DRAWINGS

The present invention is described below by reference to the following drawings, in which:

FIG. 1 schematically shows a nuclear reactor including self-powered excore detector assemblies provided outside of the reactor core in accordance with an embodiment of the present invention;

FIG. 2 shows a cross-sectional view of a detector of the self-powered excore detector assemblies shown in FIG. 1;

FIG. 3a shows an enlarged view of one of the detector assemblies from FIG. 1, and FIG. 3b shows an axial view of the detector assembly along A-A in FIG. 3a;

FIG. 4a shows an enlarged view of a detector assembly in accordance with a second embodiment of the present invention and FIG. 4b shows an axial view of the detector assembly along B-B in FIG. 4a;

FIG. 5a shows an enlarged view of a detector assembly in accordance with a third embodiment of the present invention and FIG. 5b shows an axial view of the detector assembly along C-C in FIG. 5a;

FIG. 6a shows an enlarged view of a detector assembly in accordance with a fourth embodiment of the present invention and FIG. 6b shows an axial view of the detector assembly along D-D in FIG. 6a;

FIG. 7a shows an enlarged view of a detector assembly in accordance with a fifth embodiment of the present invention and FIG. 7b shows an axial view of the detector assembly along E-E in FIG. 7a;

FIG. 8a shows an enlarged view of a detector assembly in accordance with a sixth embodiment of the present invention and FIG. 8b shows an axial view of the detector assembly along F-F in FIG. 8a;

FIG. 9a shows an enlarged view of a detector assembly in accordance with a seventh embodiment of the present invention and FIG. 9b shows an axial view of the detector assembly along G-G in FIG. 9a; and

FIG. 10 schematically shows a nuclear reactor including self-powered excore detector assemblies provided outside of the reactor core in accordance with another embodiment of the present invention.

### DETAILED DESCRIPTION

The present disclosure provides designs of excore detectors that do not require maintaining the gas volume or require an applied high voltage, or the cabling and connectors needed to supply the voltage to the detectors. The excore detectors of the present disclosure may also avoid the need for a special High Voltage insulation between the separate electrodes to avoid problems where the high voltage can begin to arc inside the detector causing unwanted spiking from various issues related to insulating gap reductions, insulating material degradation, and general design or manufacturing flaws. The excore detectors of the present disclosure may allow for a more robust solution for a wider range of operating temperatures and pressures.

The general physical structure of solid state detectors used in the incore application may work as excore detectors, but not necessarily in the emitter material or as a single solid state detector. Excore detectors typically see a thousand to tens of thousands of times less flux than an incore detector. A detector designed to provide a high enough signal inside a reactor would provide essentially no signal at the lower flux outside the reactor. So to use the same general incore solid state detector technology for excore detectors, the present disclosure uses a much stronger neutron absorber as the emitter material than in incore detectors, and/or to use detectors with longer and/or wider emitters and/or to use multiple solid state detectors in an array where they are electrically tied together to create a much larger detector as a whole. These designs may boost the signal for the excore application and the exact dimensions of each individual detector, the material used for the emitter, and the number of detectors in each array can be optimized for the individual excore application.

The emitter material required for excore detectors, in contrast to incore detectors, also needs to produce a signal in a prompt or near prompt manner so that the resulting signal can be used for immediate control and safety functions. Typical beta decay type emitter materials used for incore detectors like rhodium and vanadium cannot provide prompt signals. Prompt signals are typically produced from the thermal neutron reactions by utilizing the energetic electrons produced from the interaction of the capture gamma that was produced immediately from the neutron capture in the emitter material. These types of detectors are based on emitter materials that do not undergo beta decay as a result of the original neutron capture. Advantageous emitter materials for producing such prompt signals include for example gadolinium, cadmium and boron since certain isotopes within these materials absorb neutrons at a far higher rate than those used for incore applications. Preferably, emitter materials further include a material made of at least 75% of at least one of gadolinium, cadmium or boron, or a material made of at least 80% of at least one of gadolinium, cadmium or boron, or a material made of at least 95% of at least one of gadolinium, cadmium or boron.

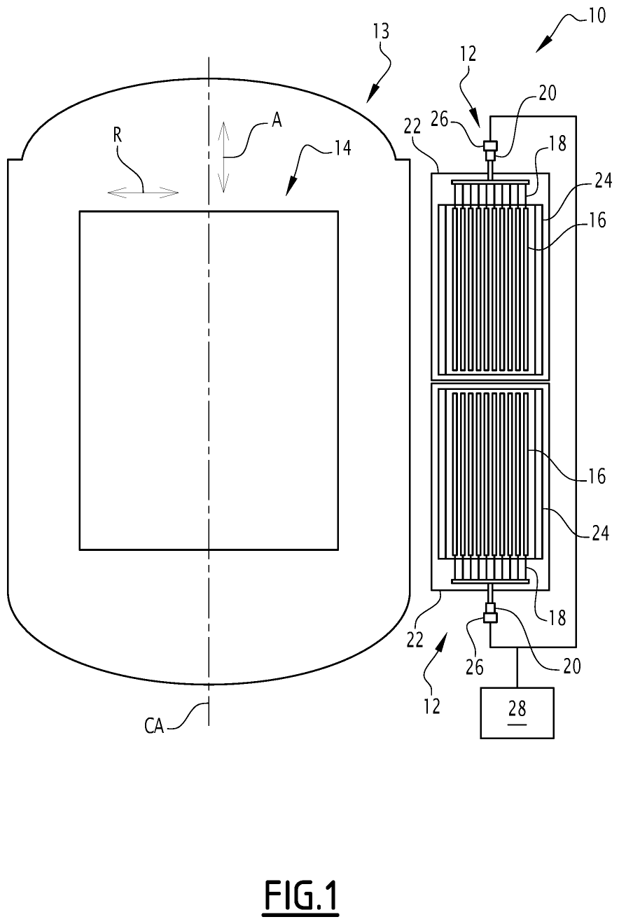

FIG. 1 schematically shows a nuclear reactor 10 including self-powered excore detector assemblies 12 provided outside of a nuclear reactor pressure vessel 13 to measure radiation emitted by a reactor core 14 of pressure vessel 13. Pressure vessel 13 is centered on a vertically extending center axis CA. Unless otherwise mentioned, the terms axial, radial and circumferential and derivatives thereof are used in reference to center axis CA, with radial direction R and axial direction A being shown in FIG. 1.

FIG. 1 shows two detector assemblies 12 arranged as a pair, with both detector assemblies 12 being at the same circumferential location with respect to core 14, but at different axial locations—i.e., the top detector assembly 12 is directly above the bottom detector assembly 12. Each of detector assemblies 12 is positioned axially such that each detector assembly 12 is radially aligned with approximately (+/−10%) a half of core 14. Although two detector assemblies 12 are provided in nuclear reactor 10, in other embodiments nuclear reactor 10 may be provided with more than two detector assemblies 12. In one preferred embodiment, nuclear reactor 12 includes eight detector assemblies 12, with the detector assemblies 12 arranged in pairs, and the pairs being circumferentially spaced ninety degrees from the two adjacent pairs.

Detector assembly 12 includes a plurality of self-powered excore detectors 16 in the form of SPNDs or SPDs. Each detector 16 has an elongated cylindrical shape. Each detector 16 includes a detector material, an insulator and a sheath and is provided with at least one lead connection 18 for outputting a signal indicating the flux detected by the individual detector 16. In the embodiment shown in FIG. 1, the detectors 16 are of the same configuration—i.e., same size and shape (within the context of manufacturing tolerances) and materials. Lead connections 18 of individual detectors 16 are joined together at assembly connector 20 that outputs a single signal indicating the flux detected by all of the detectors 16 in the detector assembly 12.

Detectors 16 are held together, for example by a grid-shaped holding frame that spaces the detectors 16 from each other, in a housing 22, which in one preferred embodiment is an aluminum cylindrical housing. A neutron thermalizing moderator 24 is provided inside of housing 22 between housing 22 and detectors 16 such that moderator 24 surrounds all of detectors 16 radially. In some exemplary embodiments, moderator 24 may be formed of polyethylene or graphite. In other embodiments, instead of a single moderator component surrounding all of detectors 16, individual moderators can surround each detector. For example, each detector 16 may be surrounded by an individual moderator tube. Moderator 24 increases the number of slow/thermal neutrons, which increases the amount of radiation detected by detectors 16, increasing the signal output.

As noted above, the electrical signals output by detectors 16 in response to the flux emitted by reactor core 14 are linked together with the other detectors 16 of the detector assembly 12 for outputting a combined flux signal from connector 20 of assembly 12. Such a configuration allows connector 20 to be inserted into an existing connector 26 of the power plant. Power plant connector 26 then sends the signals through wires to a power plant computer 28 configured for determining flux outside of pressure vessel 13 based on the signals from detectors 16 for display on a graphical user interface and analysis by a user for operating core 14.

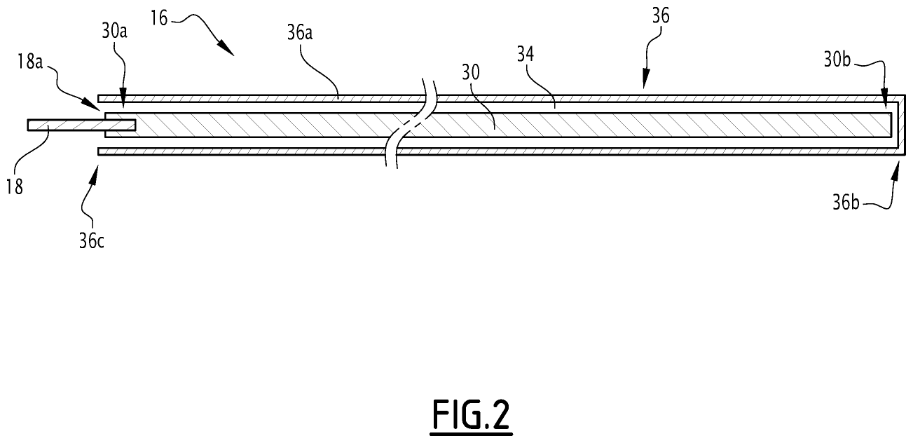

FIG. 2 shows a cross-sectional view of a detector 16. Detector 16 includes a contiguous section of a flux detecting material 30 and a flux output line in the form of a lead wire 18 extending from a first axial end 30a of detector material section 30. A first axial end 18a of lead wire 18 is embedded in first axial end 30a of detector material section 30. Detector material section 30 and a portion of lead wire 18 are embedded in an insulator 34 and directly surrounded by insulator 34 in the radial direction. Insulator 34 is directly surrounded by a sheath 36 in the radial direction and in the axial direction at the second axial end 30b of detector material section 30.

Detector material section 30 is a conducting or semiconducting material that emits electrons as a result of neutron and gamma irradiation. Material examples in preferred embodiments include gadolinium, cadmium, and boron since certain isotopes of these materials absorb neutrons at far higher rates than emitter materials used for incore applications. In one particularly preferred embodiment, gadolinium is the emitter material or the emitter material is made of at least 75%, preferably at least 80%, advantageously at least 95%, of gadolinium. Detector material section 30 is shaped as a cylindrical rod. Insulator 34 is electrically insulating and may be formed of ceramic material, for example crushed alumina. Wire 18 is formed of electrically conductive material, with each lead wire 18 conveying the flux signal emitted by the respective detector material section 30. Sheath 36 forms a collector and may be formed of for example stainless steel or Inconel. In response to neutron flux emitted from the reactor core, detector material section 30 emits electrons that flow through insulator 34 to sheath 36, causing lead wire 18 to transmit current that forms a flux signal indicating the flux in the axial location with respect to the reactor core.

Sheath 36 includes a cylindrical section radially surrounding detector material 30 section and insulator 34 and an end section 36a axially abutting the portion of insulator 34 that contacts second axial end 30b of detector material section 30. End section 36b defines a closed end of sheath 36. An axial end of sheath 36 opposite of end section 36b defines an open end 36c of sheath 36 that lead wire 18 extends through for linking to the wire 18 to the wires 18 of the other detectors 16 in the detector assembly 12.

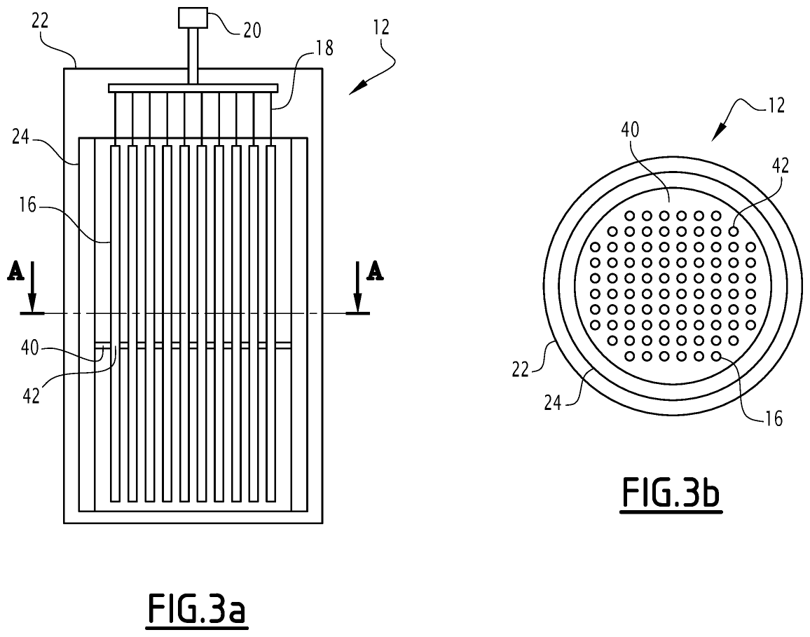

FIG. 3a shows an enlarged view of one of detector assemblies 12 from FIG. 1 and FIG. 3b shows an axial view of the detector assembly 12 along A-A in FIG. 3a. As shown in FIG. 3b, detector assembly 12 includes a plurality of rows of detectors 16, with each row including a plurality of detectors 16 that are spaced apart from each other in the circumferential and radial directions. In the example shown in FIG. 3b, detector assembly 12 includes ten rows of detectors 16, with each row including between six and ten detectors 16 for a total of eighty-eight detectors 16. In other embodiments, more or less than eighty-eight detectors can be used in each detector assembly 12. Housing 22 and moderator 24 each have a cylindrical shape with housing 22 coaxially surrounding moderator 24.

Detectors 16 are held in place by a rigid frame 40 that is fixed to moderator 24. In the embodiment shown in FIGS. 3a, frame 40 is formed as a grid including a plurality of axially extending holes 42, with each of detectors 16 passing through one of the holes 42, and an outer circumference of frame 40 is fixed to an inner circumference of moderator 24. In other embodiments, frame 40 may be fixed directly to housing 22, at for example a top or bottom of housing 22.

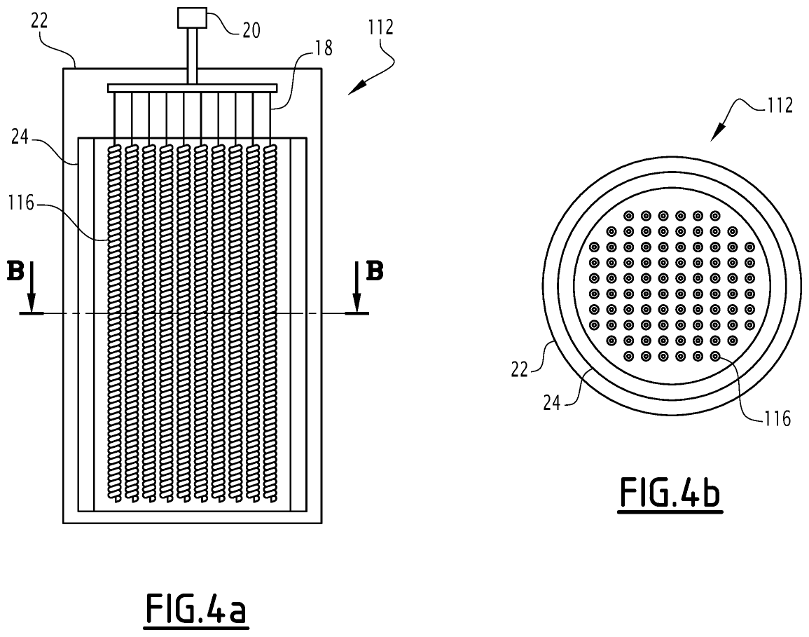

FIG. 4a shows an enlarged view of a detector assembly 112 in accordance with another embodiment of the present invention and FIG. 4b shows an axial view of the detector assembly 112 along B-B in FIG. 4a. As shown in FIGS. 4a and 4b, detector assembly 112 is configured in the same manner as detector assembly 12, except that the elongated cylindrical detectors 16 are replaced by spiral detectors 116. Like the embodiments of FIGS. 3a, 3b, detector assembly 112 includes a plurality of rows of detectors 116, with each row including a plurality of detectors 116 that are spaced apart from each other in the circumferential and radial directions. Detectors 116 are surrounded by moderator 24, which is surrounded by housing 22.

Other than the difference in shape, detectors 116 have the same construction as detectors 16. In particular, detectors 116 each include a spiral shaped flux detecting material directly surrounded by an insulator, and a sheath directly surrounding the insulator. A lead wire 18 extending from one end of the flux detecting material (the top end in FIG. 4a). Like detectors 16, detectors 116 have an elongated shape when considered as a whole. The spiral shape allows increasing the amount of flux detecting material into the detector length. The spiral shape has also shown to negate or reduce the detector response dependence to uniformly directional radiation versus a detector receiving radiation from all sides.

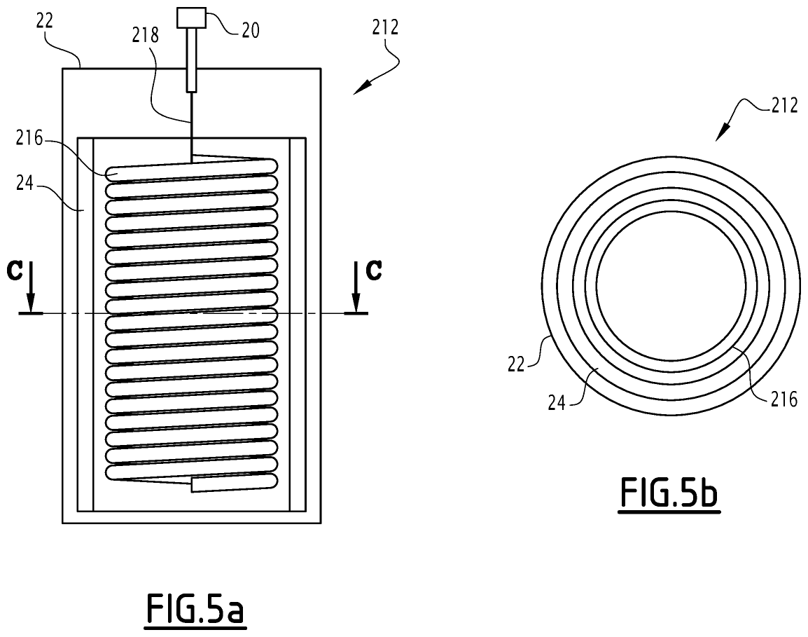

FIG. 5a shows an enlarged view of a detector assembly 212 in accordance with another embodiment of the present invention and FIG. 5b shows an axial view of the detector assembly 212 along C-C in FIG. 5a. As shown in FIGS. 5a and 5b, detector assembly 212 is configured in the same manner as detector assembly 112, except that instead of including a plurality of spiral detectors, detector assembly 212 includes a single enlarged spiral detector 216 with a single lead wire 218 feeding into connector 20. Like the embodiments of FIGS. 3a, 3b and in FIGS. 4a, 4b, spiral detector 216 has a length that extends approximately half the length of the core 14, such that two of detector assemblies 212 can cover approximately all of the height of core 14. Here and in the following, by “approximately half the length of the core 14”, it is meant preferably between 25% and 50% of the length of the core. Detector assembly 12 includes the same cylindrical housing 22 and moderator 24, with detector 216 being surrounded by moderator 24, which is surrounded by housing 22.

In the same manner as detectors 116, detector 216 includes a spiral shaped flux detecting material directly surrounded by an insulator, and a sheath directly surrounding the insulator. Lead wire 218 extends from one end of the flux detecting material (the top end in FIG. 5a). Like detectors 116, detector 216 has an elongated shape when considered as a whole, and has a hollow center to provide an increased surface area.

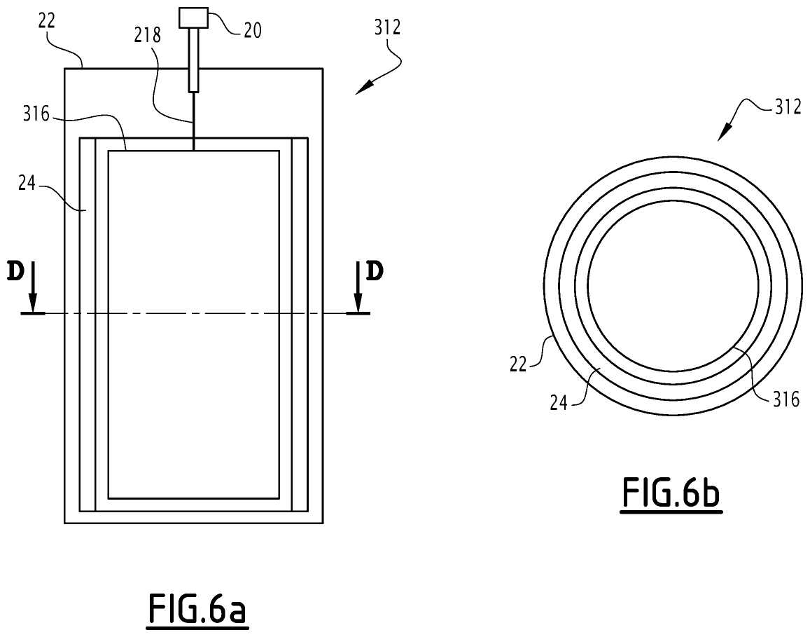

FIG. 6a shows an enlarged view of a detector assembly 312 in accordance with another embodiment of the present invention and FIG. 6b shows an axial view of the detector assembly 312 along D-D in FIG. 6a. As shown in FIGS. 6a and 6b, detector assembly 312 is configured in the same manner as detector assembly 212, except that instead of a single enlarged spiral detector 216, detector assembly 312 includes a single enlarged cylindrical detector 316 with a single lead wire 218 feeding into connector 20. Like the previously described embodiments, cylindrical detector 316 has a length that extends approximately half the length of the core 14, such that two of detector assemblies 312 can cover approximately all of the height of core 14. Detector assembly 312 includes the same cylindrical housing 22 and moderator 24, with detector 316 being surrounded by moderator 24, which is surrounded by housing 22.

In the same manner as detectors 16, detector 316 includes a cylindrically shaped flux detecting material directly surrounded by an insulator, and a sheath directly surrounding the insulator. Lead wire 218 extends from one end of the flux detecting material (the top end in FIG. 6a). Like detectors 16, detector 316 has an elongated shape.

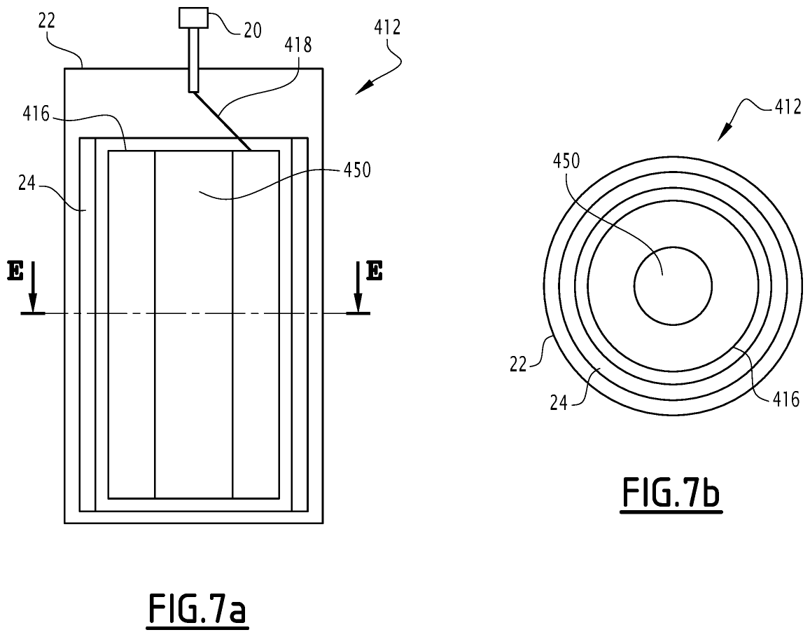

FIG. 7a shows an enlarged view of a detector assembly 412 in accordance with another embodiment of the present invention and FIG. 7b shows an axial view of the detector assembly 412 along E-E in FIG. 7a. As shown in FIGS. 7a and 7b, detector assembly 412 is configured in the same manner as detector assembly 312, except that detector assembly 412 includes a single enlarged hollow cylindrical detector 416 with a single lead wire 418 feeding into connector 20. Like the previously described embodiments, cylindrical detector 416 has a length that extends approximately half the length of the core 14, such that two of detector assemblies 412 can cover approximately all of the height of core 14. Detector assembly 412 includes the same cylindrical housing 22 and moderator 24, with detector 416 being surrounded by moderator 24, which is surrounded by housing 22.

In the same manner as detectors 16, detector 416 includes a cylindrically shaped flux detecting material directly surrounded by an insulator, and a sheath directly surrounding the insulator, with the difference being that the flux detecting material is a hollow cylinder surrounding an inner bore 450. Lead wire 418 extends from one end of the flux detecting material (the top end in FIG. 7a). Like detectors 316, detector 416 has an elongated shape.

In a further alternative of the design of detector 416, bore 450 can be filled with the same insulator material that directly surrounds the outside of the flux detecting material of detector 416.

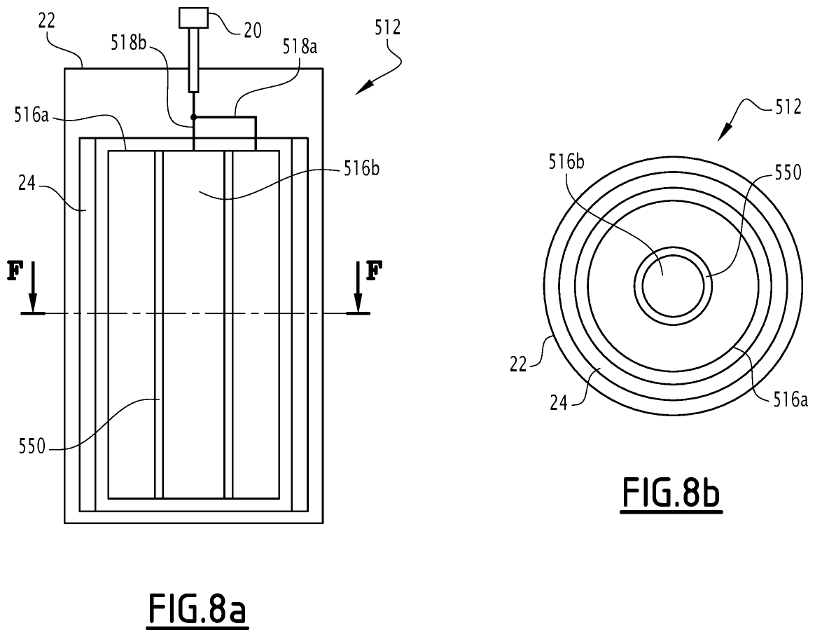

FIG. 8a shows an enlarged view of a detector assembly 512 in accordance with another embodiment of the present invention and FIG. 8b shows an axial view of the detector assembly 512 along F-F in FIG. 8a. As shown in FIGS. 8a and 8b, detector assembly 512 is configured in the same manner as detector assembly 412, except that detector assembly 512 includes an enlarged hollow cylindrical detector 516a, which is formed in the same manner as detector 416, and a solid cylindrical detector 516b in the bore 550 within detector 516a. A lead wire 518a from detector 516a is merged with a lead wire 518b from detector 518b prior to feeding into connector 20.

In the same manner as detectors 16, detector 516b includes a cylindrically shaped flux detecting material directly surrounded by an insulator, and a sheath directly surrounding the insulator. Like detectors 16, detector 516b has an elongated shape. In the embodiment shown in FIGS. 8a, 8b, the inner detector 516b and outer detector 516a are formed of the same materials and tied together electrically to create a larger detector with increased output. In other embodiments, different types of detectors may be used in such a nested arrangement having separate connectors extending outside of the housing.

Multiple outer and inner nested detectors can be tied together to make a larger detector and multiple inner detectors can be tied together, while multiple outer detectors can be tied together to build two separate larger detector types, with a separate connector for each detector type. For example, a first set of nested detectors can include a gadolinium as the detector material or a material made of at least 75%, preferably at least 80%, advantageously at least 95%, of gadolinium, and a second set of nested detectors can include boron as the detector material or a material made of at least 75%, preferably at least 80%, advantageously at least 95%, of boron.

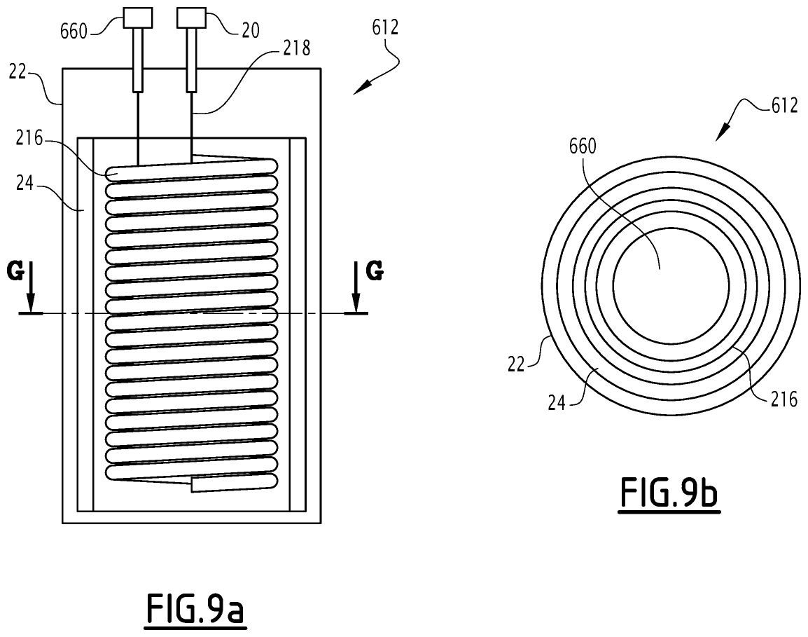

FIG. 9a shows an enlarged view of a detector assembly 612 in accordance with another embodiment of the present invention and FIG. 9b shows an axial view of the detector assembly 612 along G-G in FIG. 9a. As shown in FIGS. 9a and 9b, detector assembly 612 is configured in the same manner as detector assembly 212, except that a traditional gas volume detector 660 is provided within the bore of detector 216. Gas volume detector 660 may for example be an ionization chamber, a fission chamber or a BF3 or HE3 type chamber. Gas volume detector 660 is provided with a separate connector 662 for providing a flux signal, and also a further connector for connecting to a high voltage source.

Gas volume detector 660 can be used to measure flux at lower power ranges than detector 216. For example, as the reactor is powering up and gas volume detector 660 is in a first power range, gas volume detector 660 can be solely used to measure flux, then after the reactor enters into a second power range greater than the first power range, gas volume detector 660 can be shut off and detector 216 can be solely used to measure flux.

In one example, for a Westinghouse reactor, detector 216 can be used with a Log Amp in the range of flux E10 nv to E2 nv and detector 660 can be used with a pulse discriminating amplifier in lower power ranges of flux E2 nv to E−1 nv. In another example, detector 216 can be used with a Linear Amp in the range of flux E10 nv to E6 nv and detector 660 can used with a pulse discriminating amplifier in lower power ranges of flux E6 nv to E−1 nv. Detector 660 can be for example a fission chamber detector or a BF3 detector in such examples.

In a further alternative, any of detectors 16, 116, 216, 316, 418 can be included in the same housing 22 with each other or one of more gas volume detectors. Any of these designs can be placed in the same housing 22 and offset from each other axially for measuring different elevations in the core 14.

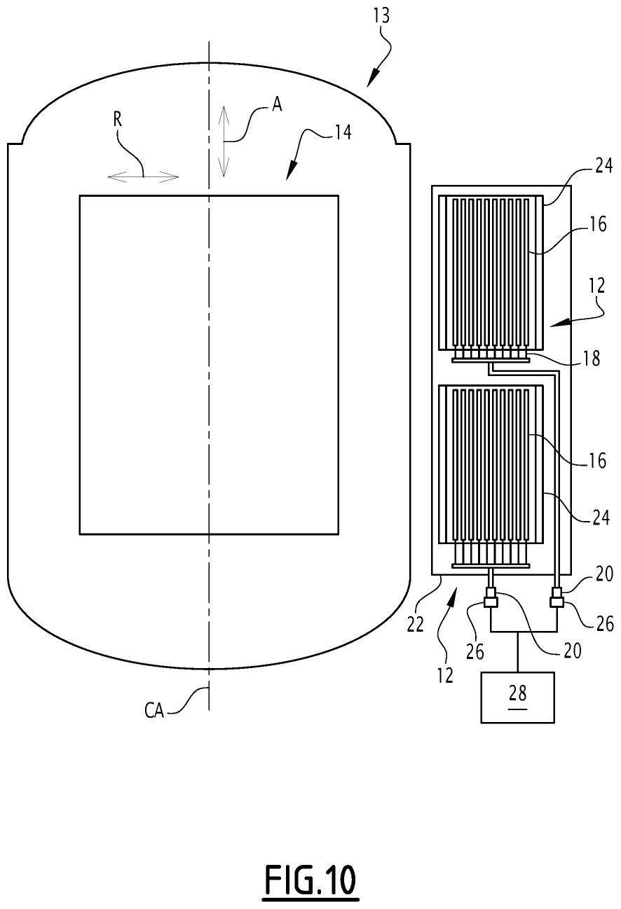

FIG. 10 schematically shows such a further alternative. In the nuclear reactor of this example, the detector assemblies 12 have the same housing 22, the detectors 16 being arranged in said housing 22. In a preferred example, for each assembly 12, the connections 18 of the assembly 12 exit the housing 22 on the same end of the housing 22. In addition, the respective connectors 20 of the assemblies 12 are arranged on the same end of the housing 22.

There are different modes of operation that the detectors of the present disclosure—e.g., detectors 16, 116, 216, 316, 418—can operate. The first mode of operation is the self-powered method used by solid state incore detectors. This method involves producing electrical signals from all the net production and depositing energetic electrons in all the layers of the detector from interactions with radiation as the sole force to create the current source. This essentially produces a deficit of electrons, i.e. a deficit of negative charge, in the emitter and so electrons flow up the wire to the emitter to fill the deficit producing positive current flow between the emitter and collector (i.e., the sheath) across the insulator.

Another mode of operation is to apply a low DC voltage, e.g., below 50 v, to the emitters and collectors to increase the force pushing the freed energetic electrons across the insulator to help increase the output current signal than would have been produced for the same number of radiation interactions with no external voltage. This low voltage mode can be helpful in increasing the signal during low reactor power where the radiation from the core is lower. This low voltage mode can also be used in testing the detectors for proper response to known voltages. Another use of such a low voltage operation is to actively supply low voltage in such a manner to calibrate the output of the detectors using different voltages on different detectors or to compare outputs from different detectors using the same known voltage.

Detectors of the present disclosure are used by measuring the current output as a relation to amount of radiation they are detecting. Another mode of operation is analyzing the noise or frequency of the signal to determine the amount of radiation being detected during very low power operation when the amount of signal needed to produce a clean measureable increasing or decreasing electrical current signal is difficult or unlikely. Such noise or frequency analysis can be used in conjunction with the self-powered or low voltage power modes.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An excore detector assembly for measuring flux outside of a nuclear reactor core comprising:
a housing; and
at least one self-powered detector inside the housing for measuring flux generated by the nuclear reactor core, the at least one self-powered detector including a sheath, a detector material section inside the sheath, an insulator between the sheath and the detector material, and a flux signal output line.

2. The excore detector assembly as recited in claim 1 further comprising at least one moderator surrounding the at least one self-powered detector.

3. The excore detector assembly as recited in claim 2 wherein the at least one self-powered detector includes a plurality of self-powered detectors, the at least one moderator being a single moderator surrounding all of the self-powered detectors.

4. The excore detector assembly as recited in claim 2 wherein the at least one self-powered detector includes a plurality of self-powered detectors, the at least one moderator being a plurality of moderator tubes, each moderator tube surrounding a respective one of the self-powered detectors.

5. The excore detector assembly as recited in claim 1 wherein the at least one self-powered detector includes a plurality of self-powered detectors.

6. The excore detector assembly as recited in claim 5 wherein each of the self-powered detectors is an elongated cylinder.

7. The excore detector assembly as recited in claim 5 wherein each of the self-powered detectors is an elongated spiral.

8. The excore detector assembly as recited in claim 5 further comprising a connector outside of the housing, the connector being connected to the flux signal output lines of the plurality of the self-powered detectors to provide a single signal for all of the plurality of the self-powered detectors.

9. The excore detector assembly as recited in claim 5 further comprising a frame inside the housing holding the plurality of self-powered detectors in place.

10. The excore detector assembly as recited in claim 5 wherein the plurality of self-powered detectors are arranged in a plurality of rows.

11. The excore detector assembly as recited in claim 1 wherein the housing is formed of a metallic material, such as aluminum, an aluminum alloy, a titanium alloy, or an austenitic nickel-chromium-based alloy.

12. The excore detector assembly as recited in claim 1 wherein the detector material section is formed of a thermal neutron reaction material capable of capturing neutrons and thereby generating capture gamma to produce energetic electrons for creating a prompt signal.

13. The excore detector assembly as recited in claim 1 wherein the detector material section is formed of gadolinium, cadmium, boron, or a material made of at least 75% of at least one of gadolinium, cadmium or boron.

14. The excore detector assembly as recited in claim 1 wherein the detector material section is formed of gadolinium, or of a material made of at least 75% of gadolinium.

15. The excore detector assembly as recited in claim 1 wherein the at least one self-powered detector includes a spiral detector including a hollow center.

16. The excore detector assembly as recited in claim 15 further comprising a further detector in the hollow center.

17. The excore detector assembly as recited in claim 16 wherein the further detector is a gas volume detector.

18. The excore detector assembly as recited in claim 1 wherein the at least one self-powered detector includes a hollow cylindrical detector.

19. The excore detector assembly as recited in claim 18 wherein the at least one self-powered detector further includes a cylindrical detector inside the hollow cylindrical detector.

20. The excore detector assembly as recited in claim 1 wherein the at least one self-powered detector has a height of approximately half of a core of the nuclear reactor pressure vessel, preferably between 25% and 50% of a core of the nuclear reactor pressure vessel.

21. A nuclear reactor comprising:
a pressure vessel; and
at least one of the excore detector assembly as recited in claim 1.
